(19) United States
(12) Patent Application Publication
(10) Pub. No.: US 2010/0293538 A1
(43) Pub. Date: Nov. 18, 2010

(54) DYNAMIC PROGRAM UPDATING IN A CONTINUATION BASED RUNTIME

(75) Inventors: Kenneth D. Wolf, Seattle, WA (US); Nathan C. Talbert, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/466,712

(22) Filed: May 15, 2009

(51) Int. Cl. G06F 9/44

(52) U.S. Cl. 717/170

(57) ABSTRACT

A computer system assigns a workflow version number to a first version of a continuation-based program. The program includes a workflow indicating when each of the program's activities is to be executed in a continuation-based runtime. The computer system stores the workflow version number in corresponding workflow instance state. The state indicates which workflow version number the workflow should be associated with. The computer system receives updates that are to be applied to the continuation-based program. The updates include an indication of which portions of the program are to be updated and an updated workflow version number. The system determines that the stored workflow version number is different than the received updated workflow version number and, based on the determination, maps the received updates from the workflow associated with the stored workflow version number to the updated workflow associated with the updated workflow version number in a revision map.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

One type of software is referred to as a “runtime”. A runtime generally provides underlying functionality that can be used by multiple different applications that run on a computing system. Some runtimes may be configured to execute activities. An activity generally represents a unit of executable code that may be part of a software application or part of an application function. As activities are executed, the runtime may be configured to track when each activity was executed and, in some cases, identify program state before and after execution.

### BRIEF SUMMARY

Embodiments described herein are directed to dynamically updating a continuation-based program in response to one or more program changes and modifying the workflow instance state of a continuation-based program. In one embodiment, a computer system assigns a workflow version number to a first version of a continuation-based program. The continuation-based program includes a workflow indicating when each of the program's activities is to be executed in a continuation-based runtime. The computer system stores the workflow version number in corresponding workflow instance state. The state indicates which workflow version number the workflow should be associated with. The computer system receives updates that are to be applied to the continuation-based program. The updates include an indication of which portions of the program are to be updated and an updated workflow version number. The computer system determines that the stored workflow version number is different than the received updated workflow version number and, based on the determination, maps the received updates from the workflow associated with the stored workflow version number to the updated workflow associated with the updated workflow version number in a revision map.

In another embodiment, a computer system receives update information indicating that a portion of state information in a continuation-based program's workflow instance state is to be updated and update the portion of state information in the workflow instance state with the received update information without modifying the program, so that updated versions of the workflow instance state reflect the updated information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including dynamically updating a continuation-based program in response to one or more program changes and modifying the workflow instance state of a continuation-based program.

FIG. 2 illustrates a flowchart of an example method for dynamically updating a continuation-based program in response to one or more program changes.

FIG. 3 illustrates a flowchart of an example method for modifying the workflow instance state of a continuation-based program.

FIG. 4 illustrates a continuation-based program before and after application of program updates.

### DETAILED DESCRIPTION

Embodiments described herein are directed to dynamically updating a continuation-based program in response to one or more program changes and modifying the workflow instance state of a continuation-based program. In one embodiment, a computer system assigns a workflow version number to a first version of a continuation-based program. The continuation-based program includes a workflow indicating when each of the program's activities is to be executed in a continuation-based runtime. The computer system stores the workflow version number in corresponding workflow instance state. The state indicates which workflow version number the workflow should be associated with. The computer system receives updates that are to be applied to the continuation-based program. The updates include an indication of which portions of the program are to be updated and an updated workflow version number. The computer system determines that the stored workflow version number is different than the received updated workflow version number and, based on the determination, maps the received updates from the workflow associated with the stored workflow version number to the updated workflow associated with the updated workflow version number in a revision map.

In another embodiment, a computer system receives update information indicating that a portion of state information in a continuation-based program's workflow instance state is to be updated and update the portion of state information in the workflow instance state with the received update information without modifying the program, so that updated versions of the workflow instance state reflect the updated information.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, as discussed in greater detail below. Embodiments within the scope of the present invention also include physical and other computer-readable storage media for carrying or storing computer-executable instructions and/or data structures. Such computer-readable media can be any available media that can be accessed by a general purpose or special purpose computer system. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

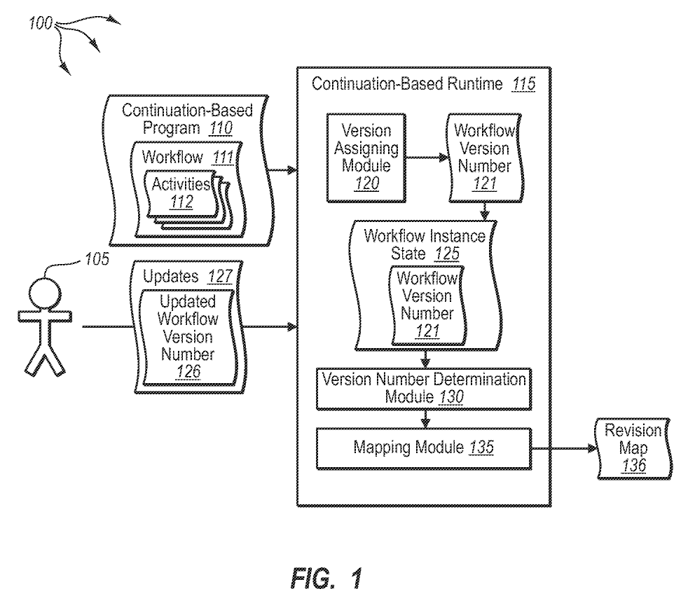

FIG. 1 illustrates a computer architecture 100 in which the principles of the present invention may be employed. Computer architecture 100 includes continuation-based runtime 115. Continuation based runtime 115 executes activities (e.g. 112). As used herein, an activity represents a unit of executable code including one or more work items. One of the ways an activity can execute multiple work items is through the scheduling of child activities. This composition of activities enables custom control flows that can be implemented through the scheduling of child activities 0, 1 or n times as determined by the composite activity.

An activity can also setup a resumable continuation in its execution that is resumed by a stimulus external to the runtime. The continuation-based runtime (CBR) may interpret this external stimulus as another item of work to be handled by the activity. Work items are represented internally as continuations that the runtime invokes on activities. Beyond this flexibility to create control flows and handle external resumptions, activities have the following characteristics: they have no process affinity (i.e. they can be paused and resumed in a different process), they have no thread affinity (i.e. different items of work can be run on different threads), and they can be stored and reloaded at a later point in time.

Continuation-based runtime 115 may be configured to execute activities 112 which are part of a continuation-based program 110. Program 110 includes workflow 111 which includes corresponding activities 112 which may each include one or more associated work items. It should be understood that program 105 may include multiple workflows, multiple activities, multiple work items, etc. In some embodiments, CBR 115 includes version assigning module 120 that is configured to assign a workflow version number 121 to a workflow instance. This workflow version number may be stored in workflow instance state 125. It should be understood that the version number 121 may be any type of numerical or textual identifier and may or may not include other symbols as well. In general, the workflow version number is a decimal number that is incremented each time the workflow (or the workflow's corresponding continuation-based program) is updated.

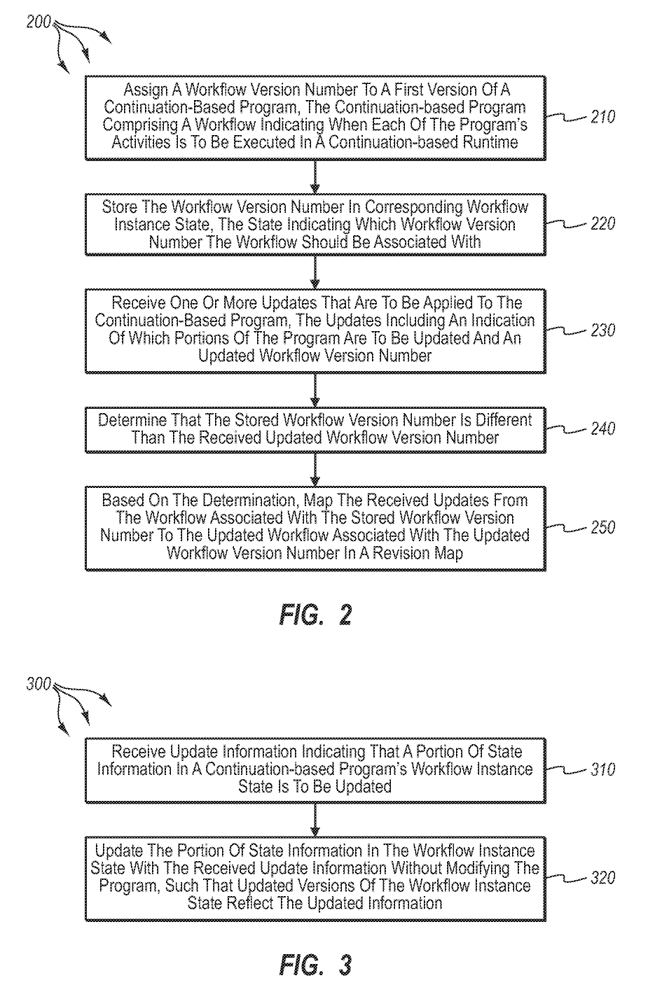

Workflow instance state 125 is typically configured to store one or more portions of state information relating to workflow 111, although it may be configurable to store information regarding continuation-based program 110 and/or activities 112. Continuation-based runtime 115 may receive updates 127 for a program or workflow. The updates may include an updated workflow version number 126 that may be different than workflow version number 121. Accordingly, continuation-based program 110 may be run for the first time, receive a version number from module 120 and continue operating using that version number until an update is received. When the updates are received, version number determination module 130 may be configured to determine that the updated workflow version number 126 is different than the currently assigned workflow number 121. When it is determined that the two versions are different, CBR 115 may be configured to create a revision map 136 using mapping module 135. The creation of the revision map 136, along with version number updating will be explained in greater detail below with regard to method 200 of FIG. 2.

FIG. 2 illustrates a flowchart of a method 200 for dynamically updating a continuation-based program in response to one or more program changes. The method 200 will now be described with frequent reference to the components and data of environment 100.

Method 200 includes an act of assigning a workflow version number to a first version of a continuation-based program, the continuation-based program comprising a workflow indicating when each of the program's activities is to be executed in a continuation-based runtime (act 210). For example, version assigning module of CBR 115 may assign workflow version number 121 to a first version of continuation-based program 110. Program 110 may include workflow 111 which indicates when each of program 110's activities 112 are to be executed in CBR 115. In some cases, continuation-based program 110 may include information about the program's current version or revision number. In other cases, CBR 115 may identify the program and assign a version number to the program. In this manner, the runtime may keep track of all of the programs running in the runtime, including the program's corresponding version numbers.

Method 200 includes an act of storing the workflow version number in corresponding workflow instance state, the state indicating which workflow version number the workflow should be associated with (act 220). For example, assigned workflow version number 121 may be stored in workflow instance state 125. The workflow instance state indicates which workflow version number the workflow should be associated with. Accordingly, if a continuation-based program is run on multiple threads, or is long-running and is unloaded for a period of time and then reloaded, the stored workflow instance state 125 will indicate which version number the workflow is associated with. Thus, CBR 115 may maintain a correspondence between continuation-based programs being processed and the workflow versions they are to be processed with.

In some cases, a workflow's instance state may include multiple portions of state, where each portion of state corresponding to a different workflow activity. For instance, workflow version 5.0 may include version 2.1 of activity A and version 1.6 of activity B, etc. Accordingly, version assigning module 120 may be configured to assign version numbers to individual activities and version number determination module 130 may be configured to determine that one or more of the activities has a new version number. This information may be used to update the entire workflow to a new version, or to update various activities to newer versions.

In some embodiments, a copy of each program version may be stored in a data store (database, local storage, distributed storage or other type of data store). Thus, if a program owner or user wishes to roll back to a previous version or simply wishes to run or view the code in a previous form, the version is stored and is accessible. Moreover, it should be noted that, in addition or as an alternative to storing the program, a workflow, activity or selected group of workflows or activities may be (automatically) stored at each revision.

Method 200 includes an act of receiving one or more updates that are to be applied to the continuation-based program, the updates including an indication of which portions of the program are to be updated and an updated workflow version number (act 230). For example, CBR 115 may receive updates 127 that are to be applied to continuation-based program 110. The updates may include an indication of which portions of the program 110 are to be updated and may also include an updated workflow version number. As mentioned earlier, the updated workflow version number 126 may include updated numbers for individual activities 112. The updates 127 may include code changes to the program 110, to the workflow 112 or to any of the workflow's activities, or changes to any combination of the program, workflow and activities. The updates may include minor changes (which may be referred to as point releases (e.g. where a version number changes from 2.1 to 2.2)) or the updates may include major changes (which may be referred to as a new version (e.g. where the version number changes from 1.0 to 2.0)).

Updates 127 may include an addition, removal or replacement of an activity (or child activity), an addition, removal or replacement of a program variable, or a modification of an argument expression. Many other types of program updates are also possible. In some cases, the workflow version number and update information are end-user accessible. In such cases, user 105 may access and/or change a version number and may supply updates which are to be applied to a given continuation-based program. Program 110 and/or workflow 111 may be automatically updated at load time to an appropriate version based on associated policy. Accordingly, if an associated policy indicates that the program or workflow is to be updated, the CBR will initiate the update process at load time and update the program/workflow. Such a policy may also indicate what is to occur when an automatic update fails. For example, the policy may indicate that the CBR is to revert back to the prior version or to a different version altogether upon load failure.

Method 200 includes an act of determining that the stored workflow version number is different than the received updated workflow version number (act 240). For example, version number determination module 130 may determine that the stored workflow version number 121 (stored in workflow instance state 125) is different than the received updated workflow version number 126. As mentioned above, module 130 may be configured to analyze program version numbers, workflow version numbers and/or activity version numbers. In some cases, the activity numbers are subsets of the workflow version number.

Method 200 also includes, based on the determination, an act of mapping the received updates from the workflow associated with the stored workflow version number to the updated workflow associated with the updated workflow version number in a revision map (act 250). For example, based on the version number determination, mapping module 135 may map the received updates 127 from the workflow associated with the stored workflow version number (e.g. where workflow 111 is associated with stored workflow version number 121) to an updated version of workflow 111 associated with updated workflow version number 126. The mapping may be stored as a revision map 136. The revision map may indicate those changes that are to be (or were) made when changing from an initial version to an updated version, including changes to the program, workflow and/or activities.

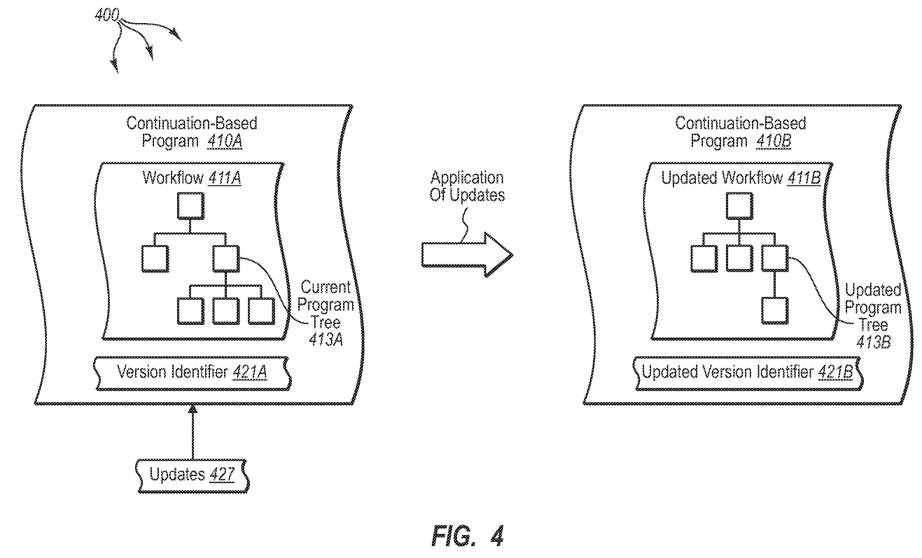

In some cases, as illustrated in environment 400 of FIG. 4, mapping the received updates 427 from the workflow 411A associated with the stored workflow version number 421A to the updated workflow 411B associated with the updated workflow version number 421B in a revision map includes generating a revision map by performing the following: adding any received update information 427 to the continuation-based program 410A's current program tree 413A, applying the added update information to the program tree, generating a revision map by determining one or more differences between the current program tree and the updated program tree 413B that includes the added update information, and accessing the updated program tree 413B to perform the following: extract the generated revision map from the updated program 410B and modifying the program's workflow instance state according to the extracted revision map.

Accordingly, FIG. 4 illustrates, among other things, a visual change in a workflow's program tree when updates 427 are applied. Thus, in some cases, a workflow defining when and how activities and child activities are to be executed in a program tree may be changed to add or remove activities, change the order of execution or apply any other changes. Accordingly, mapping module 135 may keep track of the changes made from one program tree to another, and may export those changes into a revision map 136. Thus, revision map 136 may include a list of all those changes made to a program, workflow or activity for a given revision of that program/workflow/activity.

Mapping module 135 may, additionally or alternatively, be configured to track and apply generated revision maps 136 to various different continuation-based programs as each program is updated. Accordingly, as programs, workflows and activities are updated over time and various revisions are introduces, previously updated workflows, etc. may be updated and previous version information may be stored or discarded. In some cases, determining differences between the current program tree 413A and the updated program tree 413B that includes the added update information includes accessing at least one previously updated workflow to ensure that the newer updates do not conflict with the previous updates. By accessing the previously updated workflow, the runtime can check for conflicts to prevent problems that could be caused by updating to a newer version. In cases where previously updated instances are accessible, CBR 115 may select from among a live workflow instance and a stored workflow instance based on which version is indicated in the workflow instance state (e.g. in workflow version number 121).

FIG. 3 illustrates a flowchart of a method 300 for modifying the workflow instance state of a continuation-based program. The method 300 will now be described with frequent reference to the components and data of environment 100.

Method 300 includes an act of receiving update information indicating that a portion of state information in a continuation-based program's workflow instance state is to be updated (act 310). For example, continuation-based runtime 115 may receive update information indicating that a portion of state information in workflow instance state 125 is to be updated. The update information may be configured to update workflow version number 121 or any other portion of workflow instance state that describes a particular workflow instance (e.g. 111).

Method 300 also includes an act of updating the portion of state information in the workflow instance state with the received update information without modifying the program, such that updated versions of the workflow instance state reflect the updated information (act 320). For example, CBR 115 may update the workflow version number 121 in the workflow instance state 125 with the received updated workflow version number 126. Workflow instance state 125 then includes the updated workflow version number 126. In some cases, updates 127 may include a portion of functional program information that is designed to update the continuation-based program's workflow or other program 110 functionality. In such cases, the updates can be applied by CBR 115 and are reflected in the workflow instance.

In some embodiments, continuation-based runtime may be configured to automatically update the program/workflow/activities when the workflow instance is loaded whenever corresponding updates are received. Mapping module 135 may generate a revision map 136 based on the differences between an initial version of the workflow instance state and an updated version, as explained above. In some cases, if one or more revision maps already exist in a revision map collection corresponding to a given continuation-based program, the newly generated revision map is added to the collection of revision maps. As such, a continuation-based program such as 110 may include a plurality of different revision maps detailing all of the changes made in each revision. In some cases, the revision map may be used to revert to previous versions or to determine how a program was processed in earlier versions.

Accordingly, a workflow's instance state may be modified without altering the functionality of the program. This allows for various changes to be implemented without altering a program's core modules. Moreover, changes made from one version to another can be mapped and stored in revision maps. These revision maps can be used to revert to a prior program version or to view how a program was operating in a given version.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including a processor and a memory, in a computer networking environment including a plurality of computing systems, a computer-implemented method for dynamically updating a continuation-based program in response to one or more program changes, the method comprising:
an act of assigning a workflow version number to a first version of a continuation-based program, the continuation-based program comprising a workflow indicating when each of the program's activities is to be executed in a continuation-based runtime;
an act of storing the workflow version number in corresponding workflow instance state, the state indicating which workflow version number the workflow should be associated with;
an act of receiving one or more updates that are to be applied to the continuation-based program, the updates including an indication of which portions of the program are to be updated and an updated workflow version number;
an act of determining that the stored workflow version number is different than the received updated workflow version number; and
based on the determination, an act of mapping the received updates from the workflow associated with the stored workflow version number to the updated workflow associated with the updated workflow version number in a revision map.

2. The method of claim 1, wherein the workflow's instance state comprises multiple portions of state, each state portion corresponding to a different workflow activity.

3. The method of claim 1, wherein mapping the received updates from the workflow associated with the stored workflow version number to the updated workflow associated with the updated workflow version number in a revision map comprises generating the revision maps by performing the following:
an act of adding any received update information to the continuation-based program's current program tree;
an act of applying the added update information to the program tree;
an act of generating a revision map by determining one or more differences between the current program tree and the updated program tree that includes the added update information; and
an act of the runtime accessing the updated program tree to perform the following:
an act of extracting the generated revision map from the updated program; and
an act of modifying the program's workflow instance state according to the extracted revision map.

4. The method of claim 3, further comprising tracking and applying generated revision maps to one or more different continuation-based programs.

5. The method of claim 1, further comprising an act of storing one or more copies of the program across each program revision.

6. The method of claim 1, wherein the workflow version number and update information are end-user accessible.

7. The method of claim 1, further comprising an act of automatically updating one or more workflows at load time to an appropriate version for each based on associated policy.

8. The method of claim 7, wherein the associated policy indicates what is to occur when an automatic update fails.

9. The method of claim 1, wherein a program update includes an addition, removal or replacement of a child activity.

10. The method of claim 1, wherein a program update includes an addition, removal or replacement of a variable.

11. The method of claim 1, wherein a program update includes a modification of an argument expression.

12. The method of claim 3, further comprising an act of updating a previously updated workflow.

13. The method of claim 12, wherein determining one or more differences between the current program tree and the updated program tree that includes the added update information further comprises accessing at least one previously updated workflow to ensure that the newer updates do not conflict with the previous updates.

14. The method of claim 1, further comprising an act of selecting from among a live workflow instance and a stored workflow instance based on which version is indicated in the workflow instance state.

15. A computer program product for implementing a method for modifying the workflow instance state of a continuation-based program, the computer program product comprising one or more computer-readable storage media having stored thereon computer-executable instructions that, when executed by one or more processors of the computing system, cause the computing system to perform the method, the method comprising:
an act of receiving update information indicating that a portion of state information in a continuation-based program's workflow instance state is to be updated; and
an act of updating the portion of state information in the workflow instance state with the received update information without modifying the program, such that updated versions of the workflow instance state reflect the updated information.

16. The computer program product of claim 15, further comprising:
an act of receiving update information indicating that a portion of functional program information in the continuation-based program's workflow is to be updated; and
an act of updating the functional program information in the workflow, such that updated versions of the workflow reflect the updated functional program information.

17. The computer program product of claim 15, wherein the workflow instance state is automatically updated with the received update information when the workflow instance is loaded.

18. The computer program product of claim 15, further comprising an act of generating a revision map based on the differences between an initial version of the workflow instance state and the updated version.

19. The computer program product of claim 18, wherein if one or more revision maps already exist in a revision map collection corresponding to the continuation-based program, the newly generated revision map is added to the collection of revision maps.

20. A computer system comprising the following:
one or more processors;
system memory;
one or more computer-readable storage media having stored thereon computer-executable instructions that, when executed by the one or more processors, causes the computing system to perform a method for dynamically updating a continuation-based program in response to one or more program changes, the method comprising the following:
an act of assigning a workflow version number to a first version of a continuation-based program, the continuation-based program comprising a workflow indicating when each of the program's activities are to be executed in a continuation-based runtime;
an act of storing the workflow version number in corresponding workflow instance state, the state indicating which workflow version number the workflow should be associated with;
an act of receiving one or more updates that are to be applied to the continuation-based program, the updates including an indication of which portions of the program are to be updated and an updated workflow version number;
an act of determining that the stored workflow version number is different than the received updated workflow version number; and
based on the determination, an act of mapping the received updates from the workflow associated with the stored workflow version number to the updated workflow associated with the updated workflow version number in a revision map, wherein the mapping includes the following:
an act of adding any received update information to the continuation-based program's current program tree;
an act of applying the added update information to the program tree;
an act of generating a revision map by determining one or more differences between the current program tree and the updated program tree that includes the added update information; and
an act of the runtime accessing the updated program tree to perform the following:
an act of extracting the generated revision map from the updated program; and
an act of modifying the program's workflow instance state according to the extracted revision map.
